(19) United States
(12) Patent Application Publication
(10) Pub. No.: US 2002/0076021 A1
(43) Pub. Date: Jun. 20, 2002

(54) Calling party identification

(76) Inventors: Ismael Lopez, Berwyn, IL (US); Lei Qian, Naperville, IL (US)

Correspondence Address: Docket Administrator (Rm. 3C-512), Lucent Technologies Inc., 600 Mountain Avenue, P. O. Box 636, Murray Hill, NJ, 07974-0636, US

(21) Appl. No.: 09/739,567

(22) Filed: Dec. 18, 2000

(51) Int. Cl. H04M 1/64; H04M 15/06; H04M 5/00

(52) U.S. Cl. 379/142.01; 379/88.2; 379/88.21; 379/245; 379/247

(57) ABSTRACT

This is a service which can be offered by a telephone service provider to enable a caller ID subscriber to now positively determine the identity of a member of a defined group regardless of the phone number from which the call is made. The subscriber-defined group can have a maximum of ten members with assigned numbers from 0 to 9. Specifically, the subscriber can assign a number, i.e., the number 1 to a person such as his/her mother. Now, when the subscriber's mother calls the subscriber, the number of the phone from which the call is made will appear as the caller ID number plus the number 1. Thus, regardless of the phone from which the call is made, be it from a pay phone or a friend's phone, the number 1 will identify the caller as being the subscriber's mother. In another embodiment, a name can be used in place of the number and, therefore, the name Mom can appear instead of the number 1.

### BACKGROUND OF THE INVENTION

1. Field of the Invention

This invention relates to calling party identification, and in particular to the provision of identifying the calling party regardless of the phone used to make the call.

2. Background of the Invention

Caller ID is a service by a telephone service provider that provides a user with information regarding an incoming call. Typically, a display associated with a user's telephone, either integrated into the telephone or as part of an adjunct box coupled to the telephone, displays the telephone number and/or name associated with an incoming call. In Type I Caller ID, which occurs when the user's telephone is in an on-hook state (i.e., the user is not already engaged in a telephone call while the incoming call is arriving), the Caller ID data is provided by a central office of the service provider as frequency shift keying (FSK) data between the first and second rings. The user, after the first ring, can thus look at the display to decide, based on the displayed information, whether to answer an incoming telephone call.

In Type II Caller ID, also known as Caller ID with Call Waiting (CID/CW), the user's telephone is in an off-hook state, ie., already engaged in a telephone call while the incoming call is arriving). In addition to the familiar audible tone, known as a Subscriber Alert Signal (SAS tone), that alerts a user to an incoming call waiting telephone call, the central office provides a Caller ID Alert Signal (CAS tone) to inform the user's telephone equipment that Caller ID data is about to be transmitted, pending receipt of an acknowledgment from the user's telephone equipment. Based of the CAS tone, the user's telephone briefly mutes its transducers (i.e., microphone and speaker) so that the FSK data in not heard by the user or corrupted by the user's speech. The muting period is sufficiently brief that it does not appreciably disrupt the voice communication between the parties to the conversation. The user, after hearing the SAS tone, can then view the display to determine whether to flash-hook over to the incoming call and temporarily place the existing call into a hold status. The flash-hook operation is accomplished by briefly pressing or activating a switch-hook button, which is normally in a first position, such as down, when the telephone is on-hook, and in a second position, such as up, when the telephone is off-hook, to alert the central office to the desire to switch to the incoming call.

When a telephone is equipped to receive Type II Caller ID data, a user who elects to flash-hook to an incoming call, based, for example, on viewing the Caller ID data associated with the incoming call, may subsequently decide to switch back to the original call and temporarily place the newer call in a hold status, and can do so by again activating the switch-hook. The user can decide to hold status, and can do so by again activating the switch-hook. The user can switch back and forth between the two calls as often as desired. However, activation of the switch-hook does not automatically result in a flash-hook operation. Frequently, the flash-hook operation does not occur, and the user thus must verbally confirm the identity of the distant party when switching between calls.

As frequently happens, when a Caller ID subscriber receives a call, the subscriber may choose not to answer the phone, especially if the subscriber is not familiar with the number displayed on the handset. However, the subscriber may not want to miss the call if it is from a close family member or friend who may be calling from a totally unfamiliar phone such as a payphone. There is a need, therefore, for a process for automatically providing the user with the identity of the presently connected caller regardless of the phone from which the call is made.

### SUMMARY OF THE INVENTION

This is a service which can be offered by a telephone service provider to enable a caller ID subscriber to now positively determine the identity of a member of a defined group regardless of the phone number from which the call is made. The subscriber-defined group can have a maximum of ten members with assigned numbers from 0 to 9. Specifically, the subscriber can assign a number, i.e., the number 1 to a person such as his/her mother. Now, when the subscriber's mother calls the subscriber, the number of the phone from which the call is made will appear as the caller ID number plus the number 1. Thus, regardless of the phone from which the call is made, be it from a pay phone or a friend's phone, the number 1 will identify the caller as being the subscriber's mother. In another embodiment, a name can be used in place of the number and, therefore, the name Mom can appear instead of the number 1.

### BRIEF DESCRIPTION OF THE DRAWINGS

For a more complete understanding of the present invention, and the advantages thereof, reference is now made to the following description taken in conjunction with the accompanying drawings, in which:

FIG. 1 illustrates the Activation/Deactivation process when a call is made in accordance with the principles of the invention;

FIG. 2 illustrates the request for service process when a call is made;

FIG. 3 illustrates a screen of the subscriber's database associated with the switch in the central office with number mapping; and

FIG. 4 illustrates a screen of the subscriber's database associated with the switch in the central office with name mapping.

### DETAILED DESCRIPTION

This invention relates to a new service by a telephone service provider which allows a service subscriber to have a private Calling Party Identification group. The subscriber's private group can have a maximum of ten members with assigned numbers from 0 to 9, identified herein as Group Member Identification Number (GMIN). For example, the subscriber can assign the number 1 to his/her mother so that the subscriber can identify the caller as being his/her mother when the number 1 appears in the GMIN field. It is to be noted that the GMIN is under the control of the subscriber and that it does not have to be registered with the service provider.

To avoid false phone calls, members of the private group need to input the subscriber's Personal Identification Number (PIN) when using the service here disclosed. The PIN is assigned to the subscriber by the service provider. Thus the full identification input number when using this service is *99+PIN+GMIN in addition to the telephone number that is being called. The number *99, which is designated by the service provider, is the prefix for the Calling Party Identification service here disclosed.

To originate a call having the Calling Party Identification (CPI) service here disclosed, the caller dials *99+Telphone Number of the subscriber where it is here assumed that *99 is the CPI service code number. Immediately thereafter the caller is asked to provide the full identification number, i.e., the PIN+the Group Member Identification Number (GMIN) through a playback announcement that can be provided by the control switch in the central office. Thus, if it is assumed that the subscriber's PIN is 3344, then the caller, the subscriber's mother in this example, will input the numbers 3344-1 to identify herself. The collected digits, the Telephone Number+3344-1 are sent to the subscriber's database for processing.

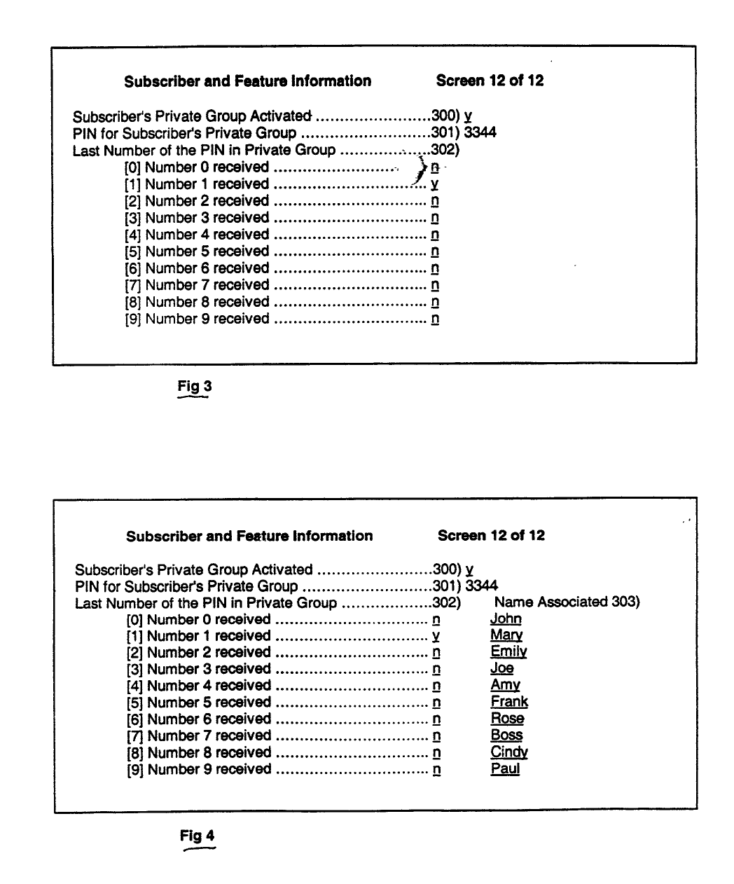

The implementation of this invention can be done in the subscriber's database associated with the central station or with a Stand Alone Home Location Registration (SHLR). This database is shared by all phone subscribers that are served by this switch. It stores subscription information of the phone users, such as the phone serial number, call restrictions that are applied to this phone, and whether it has call waiting, call forwarding, caller ID and the like. By entering the subscriber's phone number, e.g., 7082678215, the phone service provider can query or modify the subscription information under this phone number. With this invention, a new field is added in the subscriber database herein called “Subscriber's Private Group Activated”. The default value for this field is “N(0)”. It is changed to “Y(ES)” only when the subscriber or the service provider activates this service. In addition, there is another new field herein called “PIN for Subscriber's Private Group”. This field is a 4-digit field followed by a list of ten 1-digit fields as illustrated in FIG. 3.

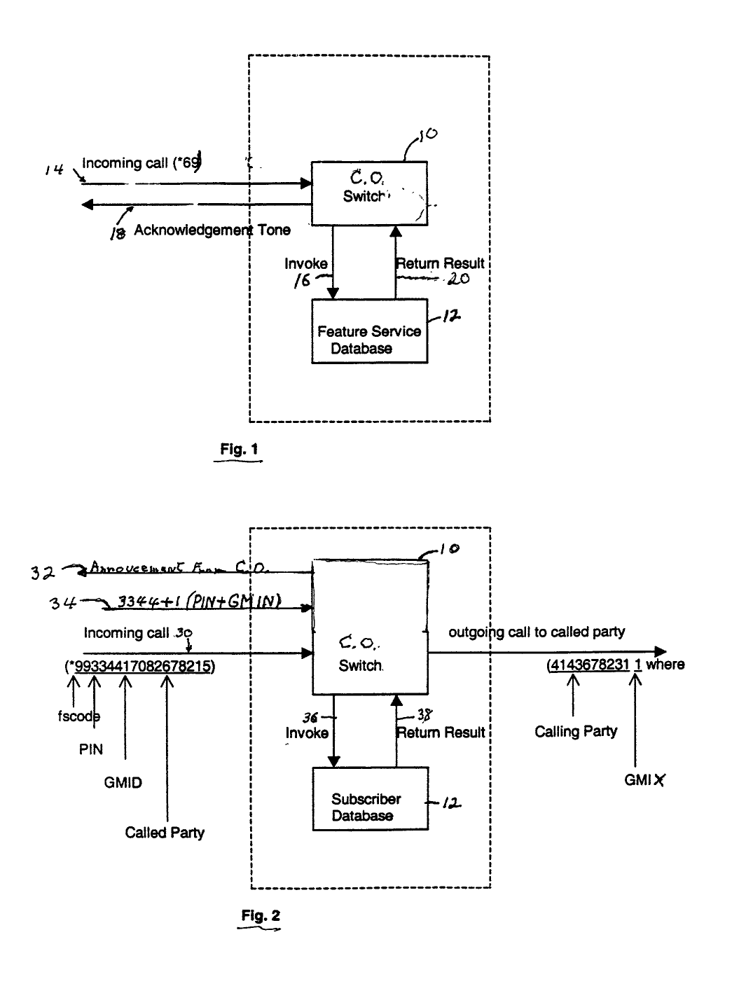

Referring to FIG. 1, there is illustrated the basic call flow process when a subscriber activates or deactivates the Call Party Identification service here disclosed. FIG. 1 discloses two components, the switch 10 in the central office and the subscriber's database 12. The subscriber's database 12 stores subscriber information of the phone users and can be either integrated with the switch in the central office or be a stand-alone database.

If it is assumed that the number *69 is the activation code for this service, and that 708-267-8215 is the subscriber's phone number, the process proceeds as follows:

A. The subscriber dials *69 to activate the Calling Party Identification service (14).

B. The central office switch 10 receives the CPI activation request from the subscriber and sends (16) a CPI service request message to the subscriber's database 12.

C. The subscriber's database 12 validates the subscriber information and updates the subscriber's private group activation to “Y(ES)”. Thereafter a CPI service request return result message is generated and sent (20) to the central office switch 10.

D. The central office switch receives the return result message and sends (18) a confirmation tone (confirmation announcement) to the subscriber.

Referring to FIG. 2, there is illustrated the basic call flow process where the Calling Party Identification feature is used. In this explanation, *99 is the Calling Party Identification (CPI) code, 3344 is the CPI service subscriber's Personal Identification Number (PIN), 1 is the Group Member Identification Number (GMIN) that is assigned by the subscriber to the subscriber's mother. Additionally, the phone number that the subscriber's mother is calling from is 414-367-8231, and the subscriber's phone number is 708-267-8215.

A. The subscriber's mother dials *99+708-267-8215 to originate a phone call (30) with the Calling Party Identification service.

B. The switch in the central office sends an announcement (32) requesting the PIN and the GMIN.

C. The subscriber's mother inputs 3344+1 (the PIN+GMIN) (reference number 34).

D. The switch in the Central office collects the digits, the phone number being called and the PIN+the GMIN (7082678215+3344+1) and sends a customer service request message to the Subscriber Database (36).

E. The subscriber database 12 verifies the qualification of the called party (708-267-8215) and determines if the called party has subscribed to this service, i.e., the “Subscriber's Private Group Activated” setting is set at “Y”, and if the PIN is matched with the “PIN for Subscriber's Private Group” which is assigned by a service provider. If the qualifications are validated, the Subscriber Database then sends a “Positive” customer service return result message (38) back to the central office switch (10).

F. The central office switch establishes the call to the called party. The calling party number that is displayed on the called party display contains the number of the phone from which the call was made plus the number (4143678231 1). Clearly, by seeing the last digit, the number 1, the called party (the subscriber to the service) knows that the call is from the subscriber's mother regardless of which phone was used to make the call.

FIG. 3 is an illustrative example of a screen listing the fields for the Calling Party Identification service here disclosed. The subscriber's database screen indicates the type of services that the subscriber has. The services can be reviewed and modified.

The “Subscriber's Private Group Activated . . . 300” line illustrates valid entries with a “Y” and an “N” when “N” is the default value. A subscriber can receive the Calling Party Identification service by dialing the service code or calling an operator. The “PIN for Subscriber's Private Group . . . 301” line illustrates valid entries which are from a 4 digit number through a 10 digit number depending on the detail of implementation,. It is default to empty. The “Last Number of the PIN in Private Group . . . 302” line illustrates valid entries from the following 10 fields (0 through 9) as being “Y” and “N” where “N” is the default value. When any group member calls the Calling Party Identification subscriber, the associated field will be changed from “N” to Y”.

FIG. 4 illustrates the embodiment where the last number of the PIN in the Private Group is mapped to a person's name. To accurately display the calling person's name to the subscriber, the subscriber of the service needs to provide the name of the private group to the service provider.

In the embodiment of FIG. 4, the calling person's name rather than a number will appear on the Caller ID screen. For example, when the subscriber's mother call the subscriber from a pay phone or a friend's house, the subscriber's Caller ID screen will display the name “Mary” whom the subscriber knows is his/her mother instead of the number 1.

Various modifications of the invention will become apparent to those skilled in the art. All such variations which basically rely on the teachings through which the invention has advanced the art are properly considered within the scope of the invention.

1. A method of providing a caller ID service which can be used to identify a caller to a caller ID subscriber comprising the steps of
assigning a first identifier to the caller ID subscriber;
assigning a second identifier to the caller;
using the first identifier to identify the caller regardless of the phone from which the call was made; and
using the second identifier to process a call from a caller to the called ID subscriber.

2. The method of claim 1 further comprising the step of assigning a prefix identifier for activating the service.

3. The method of claim 1 wherein the first identifier is a single digit number.

4. The method of claim 3 wherein the single digit number is a single digit number from 0 through 9.

5. The method of claim 1 wherein the second identifier is a PIN number.

6. The method of claim 5 wherein the PIN number has a single digit.

7. The method of claim 5 wherein the PIN number has more than a single digit.

8. The method of claim 1 further comprising the step of using the first and second identifiers to process a call from a caller to the caller ID subscriber.

9. The method of claim 8 further comprising the step of displaying the first identifier together with the caller ID display to the subscriber.

10. The method of claim 9 wherein the first identifier is a digit.

11. The method of claim 9 wherein the first identifier is a digit from 0 through 9.

12. The method of claim 9 wherein the first identifier is a name.

13. The method of claim 9 wherein the first identifier is one of ten names.

14. The method of claim 1 further comprising the step of using the first and second identifier with the phone number of the caller ID subscriber to process a call from a caller to the subscriber.

15. The method of claim 14 further comprising the step of assigning a prefix identifier to identify the service.

16. The method of claim 14 wherein the prefix identifier comprises at least two digits.

17. The method of claim 1 wherein the prefix identifier comprises two digits and the star button tone of the telephone.

18. A method of providing a caller ID service which can be used to identify a caller to a caller ID subscriber comprising the steps of
assigning an identifier to the caller; and
using the identifier to identify the caller to the subscriber regardless of the phone number from which the call was made.
